(19) United States
(12) Patent Application Publication
(10) Pub. No.: US 2006/0043189 A1
(43) Pub. Date: Mar. 2, 2006

(54) Method and apparatus for determining the vertices of a character in a two-dimensional barcode symbol

(76) Inventors: Sachin Agrawal, Mississauga (CA); Derek Kwok, Toronto (CA); Mohanaraj Thiyagarajah, Scarborough (CA); Ian Clarke, Toronto (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/930,596

(22) Filed: Aug. 31, 2004

(51) Int. Cl. G06K 7/10

(52) U.S. Cl. 235/462.08; 235/462.11

(57) ABSTRACT

A method of determining the vertices of a character in a two-dimensional barcode symbol image includes tracing a contour around a character. The contour is examined and pixels therealong believed to be vertices of the character are determined. The relative positions of the determined pixels are compared to determine if they satisfy a threshold. If the relative positions of the determined pixels satisfy the threshold, the determined pixels are designated as the vertices of the character. If the relative positions of the determined pixels satisfy the threshold, the determined pixels are designated as the vertices of the character. If the relative positions of the determined pixels do not satisfy the threshold, new pixels along the contour are selected using geometric relationships between the determined pixels to replace determined pixels that are not vertices of the character.

### FIELD OF THE INVENTION

The present invention relates generally to symbol recognition and more specifically, to a method and apparatus for determining the vertices of a character in a two-dimensional barcode symbol.

### BACKGROUND OF THE INVENTION

Marking documents with machine-readable characters to facilitate automatic document recognition using character recognition systems is well known in the art. In many industries, labels are printed with machine-readable symbols, often referred to as barcodes, and are applied to packages and parcels. The machine-readable symbols on the labels typically carry information concerning the packages and parcels that is not otherwise evident from the packages and parcel themselves.

For example, one-dimensional barcode symbols such as those following the well-known Universal Product Code (UPC) specification, regulated by the Uniform Code Council, are commonly used on machine-readable labels due to their simplicity. A number of other one-dimensional barcode symbol specifications have also been proposed, such as for example POSTNET that is used to represent ZIP codes. In each case, the one-dimensional barcode symbols governed by these specifications have optimizations suited for their particular use. Although these one-dimensional barcode symbols are easily scanned and decoded, they suffer disadvantages in that they are only capable of representing a limited amount of information.

To overcome the above disadvantage associated with one-dimensional barcode symbols, two-dimensional machine-readable symbols have been developed to allow significantly larger amounts of information to be encoded. For example, the AIM Uniform Symbology Specification For PDF417 defines a two-dimensional barcode symbol format that allows each barcode symbol to encode and compress up to 1108 bytes of information. Information encoded and compressed in each barcode symbol is organized into a two-dimensional data matrix including between 3 and 90 rows that is book-ended by start and stop patterns. Other two-dimensional machine-readable symbol formats such as for example AZTEC, QR Code and MaxiCode have also been considered.

Although two-dimensional machine-readable symbols allow larger amounts of information to be encoded, an increase in sophistication is required in order to read and decode two-dimensional machine-readable symbols. In the case of PDF417 barcode symbols, when a PDF417 barcode symbol is scanned, it is important to determine accurately the location of the stop and start patterns in the scanned barcode symbol. The stop and start patterns are used to determine rotation and distortion in the scanned barcode symbol so that the scanned barcode symbol can be properly oriented prior to reading. With the scanned barcode symbol properly oriented, the encoded data can be extracted from the barcode symbol and decoded correctly. As will be appreciated, locating the stop and start patterns in PDF417 barcode symbols accurately is therefore of great importance.

It is therefore an object of the present invention to provide a novel method and apparatus for determining the vertices of a character in a two-dimensional barcode symbol.

### SUMMARY OF THE INVENTION

Accordingly, in one aspect of the present invention there is provided a method of determining the vertices of a character in a two-dimensional barcode symbol image. During the method, a contour around the character is traced. The contour is examined and pixels therealong believed to be vertices of the character are determined. The relative positions of the determined pixels are then compared to determine if they satisfy a threshold. If the relative positions of the determined pixels satisfy the threshold, the determined pixels are designated as the vertices of the character. If the relative positions of the determined pixels do not satisfy the threshold, new pixels along the contour are selected using geometric relationships between the determined pixels to replace determined pixels that are not vertices of the character.

During the examining, pixels believed to be vertices of the character are determined in pairs. A first pair of determined pixels representing one set of vertices is initially determined and thereafter, a second pair of determined pixels believed to represent another set of vertices is estimated. The distance between each pair of pixels along the contour is compared to locate the pair of pixels having the greatest distance therebetween thereby to locate the first pair of determined pixels. The two pixels along the contour on opposite sides of a line joining the determined pixels of the first pair that are furthest from the line are then determined thereby to estimate the second pair of determined pixels. During comparing of the relative positions of the determined pixels, the perpendicular distance between each determined pixel of the second pair to the line is determined. The determined distances are then compared to determine if they vary beyond the threshold.

When the determined distances vary beyond the threshold, the selecting comprises determining the pixel along the contour that is furthest from a line joining one of the determined pixels of the first pair and the determined pixel of the second pair that is furthest from the line joining the determined pixels of the first pair and determining the pixel along the contour that is furthest from a line joining the other of the determined pixels of the first pair and the determined pixels of the second pair that is furthest from the line joining the determined pixels of the first pair.

In one embodiment, the character is generally rectangular in shape and forms part of a designated pattern in the two-dimensional barcode symbol. The designated pattern may be one of a stop and start pattern forming part of a PDF417 barcode symbol. In this case, the character is a thick bar in the pattern.

According to another aspect of the present invention, there is provided an apparatus for determining the vertices of a character in a two-dimensional barcode symbol image. The apparatus includes a contour tracer for tracing a contour around the character. A vertices determiner examines the contour and determines pixels along the contour believed to be vertices of the character. A vertices corrector compares the relative positions of the determined pixels to determine if they satisfy a threshold. If the relative positions of the determined pixels satisfy the threshold, the vertices corrector designates the determined pixels as the vertices of the character. If the relative positions of the determined pixels do not satisfy the threshold, the vertices corrector selects new pixels along the contour using geometric relationships between the determined pixels to replace determined pixels that are not vertices of the character thereby to correct the vertices.

According to yet another aspect of the present invention, there is provided a method of determining the vertices of a generally rectangular character in a two-dimensional barcode symbol. During the method, the character is examined to determine a first pair of vertices of the character. The determined pair of vertices is used to estimate a second pair of vertices of the character. The relative positions of the determined and estimated vertices are compared to determine if the estimated vertices are accurate. If the estimated vertices are inaccurate, the second pair of vertices are re-estimated using geometric relationships between the determined and estimated vertices.

The first pair of vertices are determined by detecting the two points along the perimeter of the character that have the greatest distance therebtween. The second pair of vertices are estimated by detecting the two points that are on opposite sides of and furthest from a line joining the vertices of the first pair. If the estimated vertices are accurate, the positions of the estimated vertices are verified and re-adjusted, if necessary.

According to still yet another aspect of the present invention, there is provided a method of decoding a two-dimensional barcode symbol in a captured image. During the method, start and stop patterns forming part of the barcode symbol are located. A contour is traced around at least a portion of each of the located start and stop patterns. The vertices of the traced contours are then determined. During the determining each traced contour is examined to determine a first pair of vertices. The determined pair of vertices are then used to estimate a second pair of vertices. The relative positions of the determined and estimated vertices are then compared to determine if the estimated vertices are accurate. If the estimated vertices are inaccurate, the second pair of vertices are re-estimated using geometric relationships between the determined and estimated vertices. The vertices are then used to re-orient the barcode symbol and the re-oriented barcode is read to extract the data therein.

The present invention provides in that the vertices of two-dimensional barcode symbol characters can be determined accurately even in the presence of distortion in the barcode symbol image. In the case of PDF417 barcode symbols, this allows the locations of stop and start patterns to be determined with a high degree of accuracy and thus, improves barcode symbol decoding resolution as the scanned barcode symbol can be properly oriented prior to reading and data extraction. In addition, the present invention allows skew and pitch angles of scanned barcode symbols to be estimated thereby to improve further barcode symbol decoding resolution.

### BRIEF DESCRIPTION OF THE DRAWINGS

Embodiments of the present invention will now be described, more fully, with reference to the accompanying drawings in which:

FIG. 1 is a schematic diagram of a two-dimensional barcode symbol decoder;

FIG. 2 shows a PDF417 symbol with a up portion thereof blown-up;

FIG. 3 is a flow chart showing the steps performed during processing of a PDF417 barcode symbol in order to extract the data therein;

FIG. 4 is a Laplacian high-pass filter kernel used to sharpen a PDF417 barcode symbol image;

FIGS. 5a and 5b show samples of noise that may appear in PDF417 barcode symbol images;

FIG. 6 is a table showing the relative widths of bars and spaces, in modules, of start and stop patterns forming part of a PDF417 barcode symbol in both forward and backward directions;

FIG. 7 is an exemplary sequence of tokens along a scan-line across a PDF417 barcode symbol representing a candidate start pattern;

FIG. 8 illustrates the modules for each token in an ideal start pattern;

FIG. 9 illustrates a comparison of the scan-line tokens of FIG. 7 with the modules for each token of FIG. 8;

FIG. 10 is a flow chart showing the steps performed during contour tracing around the thick bars of start and stop patterns;

FIG. 11 shows the pixels of an exemplary thick bar forming part of a start or stop pattern;

FIG. 12 is a flow chart showing the steps performed during determination of the vertices of the thick bar forming part of a start or stop pattern;

FIG. 13 shows the contour traced around a thick bar and the estimated vertices of the contour where the estimated vertices of the contour are inaccurate;

FIG. 14 shows the contour of FIG. 13 after the vertices have been corrected in accordance with the vertex determination method of FIG. 12;

FIG. 15 shows a contour traced around a thick bar and the estimated vertices of the contour where the estimated vertices of the contour are accurate;

FIG. 16 shows the thick bar forming part of a start or stop pattern illustrating both initial estimated vertices and adjusted vertices in accordance with the vertex determination method of FIG. 12;

FIG. 17 illustrates the vertices of the stop and start patterns in the PDF417 barcode symbol that are used to transform the PDF417 barcode symbol;

FIG. 18 illustrates the orientation of the PDF417 barcode symbol after undergoing transformation;

FIG. 19a shows a set of tokens forming a codeword in the transformed PDF417 barcode symbol; and

FIG. 19b shows a set of modules corresponding to the normalized lengths of the tokens forming the codeword of FIG. 19a.

### DETAILED DESCRIPTION OF THE INVENTION

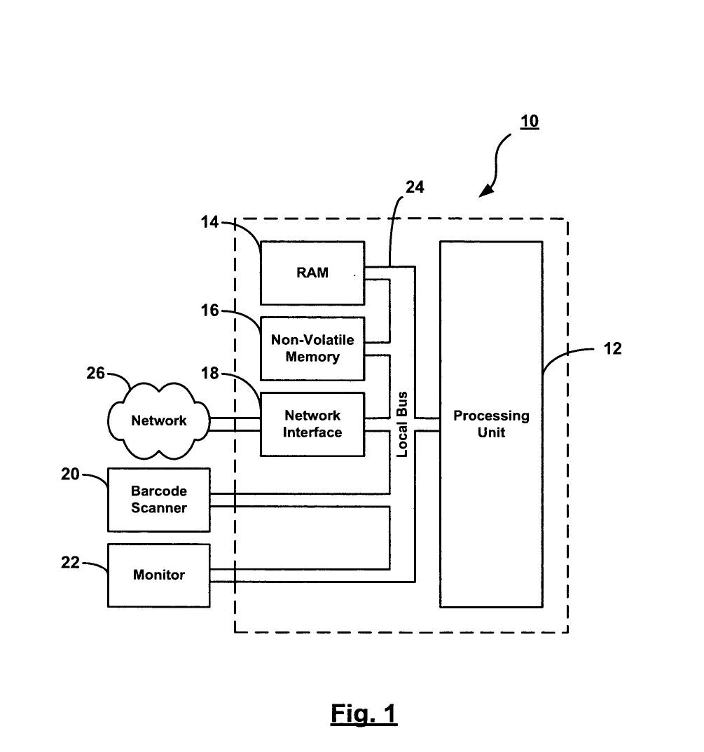

Turning now to FIG. 1, a two-dimensional barcode symbol decoder for decoding two-dimensional barcode symbols is shown and is generally identified by reference numeral 10. In this embodiment, barcode symbol decoder 10 is designed to read and recognize PDF417 barcode symbols. As can be seen, barcode symbol decoder 10 comprises a processing unit 12 including an Intel Pentium III 1GHz processor 12, that communicates with random access memory (RAM) 14, non-volatile memory 16, a network interface 18, a 200×200 DPI barcode scanner 20 and a monitor 22 over a local bus 24.

The processing unit 12 executes barcode symbol decoding software to enable PDF417 barcode symbols to be located and decoded as will be described. The non-volatile memory 16 stores the operating system and barcode symbol decoding software used by the processing unit 12. The non-volatile memory 16 also stores a table of the relative widths of bars and spaces, in modules, of start and stop patterns forming part of each PDF417 barcode symbol, in both forward and backward directions. The network interface 18 communicates with one or more information networks identified generally by reference numeral 26.

Barcode scanner 20 scans PDF417 barcode symbols on labels affixed to or printed on packages or parcels thereby to capture images of the barcode symbols. Network interface 18 allows PDF417 barcode symbol images to be uploaded from one or more information networks 26 and permits remote software maintenance.

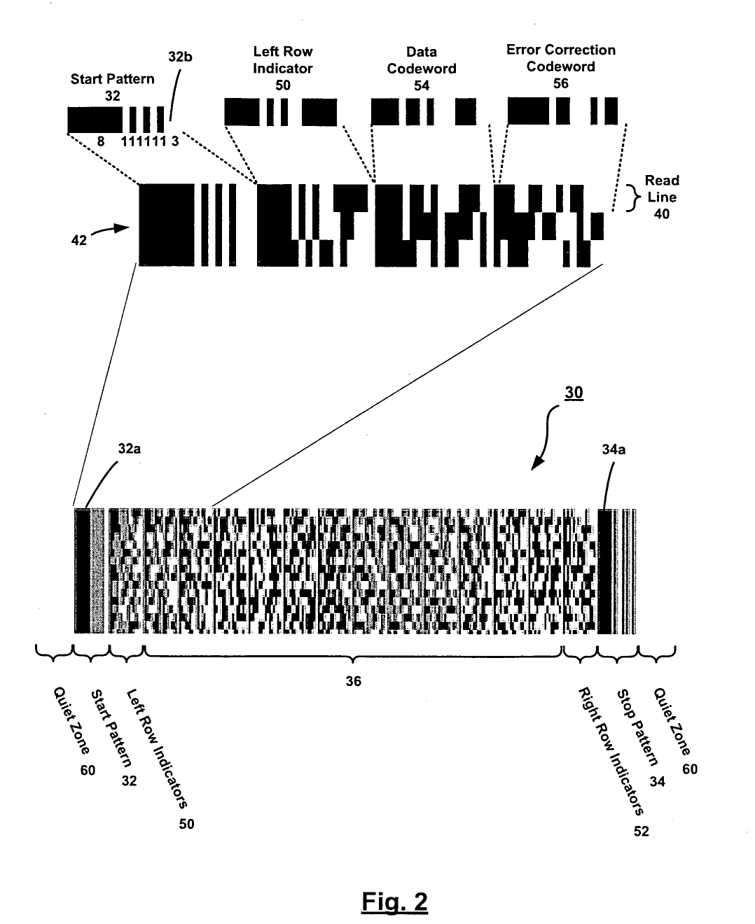

FIG. 2 shows a sample PDF417 barcode symbol 30 to be read and decoded by the barcode symbol decoder 10. As can be seen, PDF417 barcode symbol 30 comprises a start pattern 32 and a stop pattern 34 that book-end a two-dimensional data matrix 36. The start and stop patterns 32 and 34 include patterns of characters in the form of bars and spaces having pre-set widths relative to one another. The bars and spaces run the full height of the PDF417 barcode symbol 30. In particular, the start pattern 32 includes alternating bars and spaces having the following relative widths: 8, 1, 1, 1, 1, 1, 1, 3. That is, the start pattern 32 begins with a thick bar 32a having a width that is eight times as wide as the space following it, and ends with a space 32b that is three times as wide as the bar proceeding it. The stop pattern 34 also includes alternating bars and spaces having the following relative widths: 7, 1, 1, 3, 1, 1, 2, 1, 1. That is, the stop pattern 34 begins with a thick bar 34a having a width that is seven times as wide as the space following it. For space termination, the stop pattern 34 includes an additional bar having a width that is the same as the width of the space proceeding it. The difference in the number of bars in the stop and start patterns 32 and 34 allows the orientation of a scanned barcode symbol 30 to be determined.

The two-dimensional data matrix 36 disposed between the start and stop patterns 32 and 34 includes anywhere from 3 to 90 rows of data. Each row of data in the data matrix 36 is commonly referred to as a read line 40. The read lines 40 are grouped in threes with each group of read lines forming a cluster 42. The clusters 42 are numbered 0, 3, and 6. This alternating numbering allows the barcode symbol decoder 10 to confirm that the read line 40 being examined is, in fact, the proper read line 40 to be read.

Each read line 40 includes a set of codewords. Each codeword has the same width as the start pattern 32 and is represented by a set of four alternating black and white tokens. The widths of the black and white tokens in each codeword vary to allow the codewords to represent different characters. The width of each token is however, restricted to positive integral multiples of a unit, or “module”, resulting in a fixed number of modules per codeword, in this case seventeen (17). As a result, only a finite number of codewords is possible. A unique set of codewords is defined for each of the three possible clusters.

The left-most and right-most codewords of each read line 40 are designated as left row and right row indicators 50 and 52 respectively. Between the left row and right row indicators are data codewords 54 and error correction codewords 56. The left and right row indicators 50 and 52 identify the cluster to which the read line 40 belongs, the total number of read lines in the data matrix 36, the total number of codewords per read line 40, and the error correction level. The ratio of error correction codewords 56 to data codewords 54 in the read lines 40 can be varied to provide for more or less error tolerance depending on the application. A higher ratio of error correction codewords 56 to data codewords 54 increases the ability to decode barcode symbols 30 even when the barcode symbols are marred or disfigured.

Quiet zones 60 book-end the PDF417 barcode symbol 30 to facilitate locating the PDF417 barcode symbol in the image.

The general operation of the barcode symbol decoder 10 will now be described with particular reference to FIGS. 1 to 3. Upon power up, the processing unit 12 loads the operating system from the non-volatile memory 16. The processing unit 12 then loads the barcode symbol decoder software and the table from the non-volatile memory 16. Once loaded, the processing unit 12 executes the barcode symbol decoder software placing the barcode symbol decoder 10 into a ready state.

With the barcode symbol decoder 10 in the ready state, packages or parcels carrying labels with PDF417 barcode symbols 30 thereon can be processed or gray-scale PDF417 barcode symbol images can be uploaded from other information networks 26 via the network interface 18. During processing, the PDF417 barcode symbols on the labels are scanned using the barcode scanner 20 thereby to generate gray-scale images of the PDF417 barcode symbols. For each gray-scale barcode symbol, whether scanned using the barcode scanner 20 or uploaded from an information network 26, the gray-scale barcode symbol image is sharpened (step 100). Adaptive thresholding is then performed on the sharpened gray-scale barcode symbol image to convert the barcode symbol image into a binary, or black and white image (step 110). The black and white image is analyzed for noise and noise detected therein is removed thereby to clean the black and white image (step 120).

Following cleaning, a horizontal and vertical scan of the cleaned image is performed to locate candidate start and stop patterns in the barcode symbol image (step 130). The located candidate start and stop patterns are then grouped and contours are traced around the main thick bars identified in the grouped candidate start and stop patterns (step 140). The vertices of the traced contours are then determined (step 150). Next, the start and stop patterns are matched and the determined vertices are used to delineate the barcode symbol in the barcode symbol image (step 160). The delineated barcode symbol is then transformed to counter distortion thereby to allow the data contained in the read lines 40 of the data matrix 36 to be read (step 170). The data contained in the read lines 40 is then extracted (step 180) and the extracted data is processed by a bit decoder (not shown) to decode the extracted data (step 190) and thereby complete the PDF417 barcode symbol decoding process.

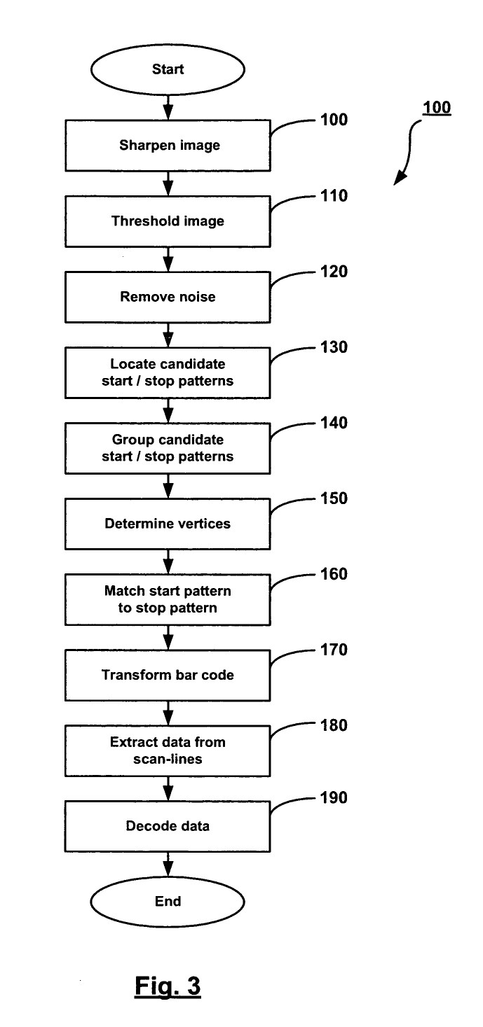

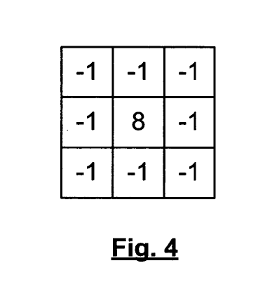

At step 100 during sharpening of the captured gray-scale barcode symbol image, a Laplacian high-pass filter as shown in FIG. 4 is applied to the gray-scale barcode symbol image to generate a filtered image. The pixel values of the resulting filtered image are then scaled to fall in the range of 0 to 255. The scaled filtered image is then added to the original gray-scale barcode symbol image and the values of the resultant combined image are again scaled to fall in the range of 0 to 255. A histogram stretch is then employed to distribute the pixel values of the resultant combined image thereby to yield the sharpened image.

During adaptive thresholding at step 110, a threshold value is determined for the sharpened image. Pixels in the sharpened image having intensity values above a threshold value are set to white and pixels having an intensity value below the threshold value are set to black. To determine the threshold value, the average intensity T of the entire sharpened image is firstly determined and is used as the initial threshold value. Pixels of the sharpened image are then partitioned into two groups based on the initial threshold value. The average gray-scale pixel values μ₁ and μ₂ are determined for each of the two groups. A new threshold value is then calculated using the following formula:
T=(μ₁+μ₂)/2 (0.1)
The above steps are then repeated until the average gray-scale pixel values μ₁ and μ₂ for each of the two groups do not change in two successive iterations. The end result is the binary or black and white version of the sharpened image.

During image cleaning at step 120, the black and white image is examined to locate pixel patterns that are deemed to represent noise. When pixel patterns deemed to represent noise are determined, the black and white image is modified to remove these pixel patterns thereby to cancel the located noise. Locating noise around the edges of the thick bars in the start and stop patterns is desired, as such noise can interfere with the correct delineation of the contours of the thick bars, which are ultimately used to determine the orientation and distortion of the scanned barcode symbol to be decoded.

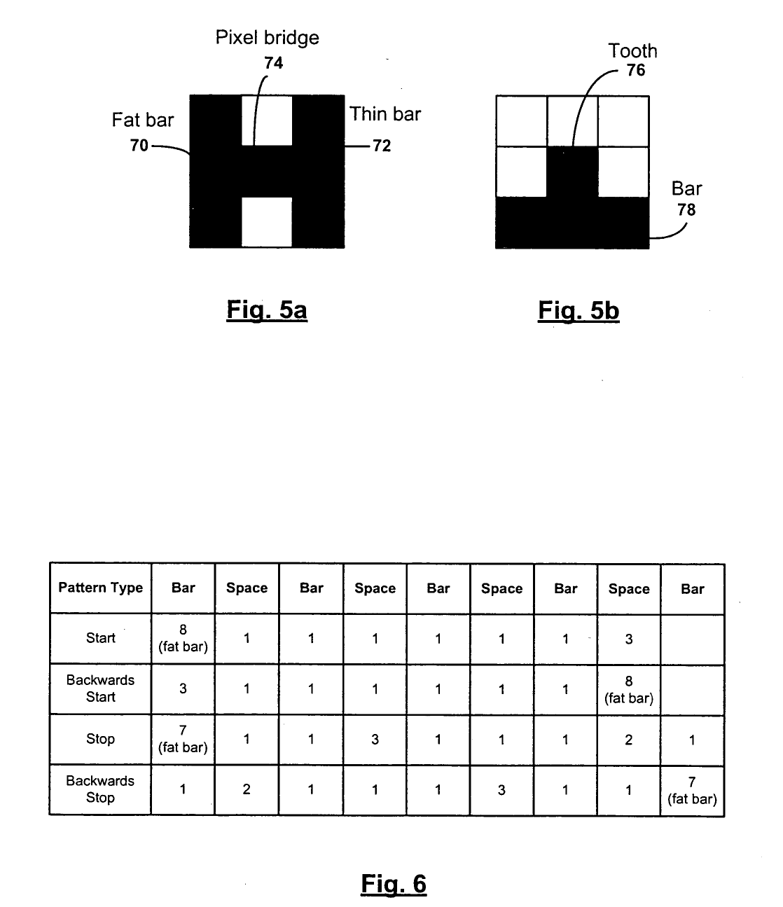

FIG. 5a illustrates one example of noise in a black and white image. In this case, the noise is adjacent a thick bar 70 in a start or stop pattern and results in the thick bar 70 being joined to a thin bar 72 by a bridge of pixels 74 of the same color. FIG. 5b illustrates another example of noise in a black and white image. In this case, the noise results in a tooth 76 protruding from a bar 78. Teeth are undesirable since they may result in incorrect pixel data being extracted from the data matrix 36 during reading along a read line 40. For instance, a read line passing through the middle row of pixels in FIG. 5b would encounter two transitions in total (white to black, and black to white), where none should be encountered.

During image cleaning, a pixel of the black and white image is firstly selected and the pixels surrounding the selected pixel are examined to determine if the selected pixel is deemed to represent noise. In particular, the pixels surrounding the selected pixel are examined to determine if their intensity values (i.e. colors) satisfy one of a number of conditions signifying that the selected pixel represents noise. For example, if all of the pixels surrounding the selected pixel are of an intensity value that is opposite the intensity value of the selected pixel, the selected pixel is determined to be a floating pixel and is deemed to represent noise. In this case, the intensity value of the selected pixel is reversed i.e. the selected pixel is switched either from black to white or white to black. If the pixels on two opposite sides of the selected pixel are of one intensity value and if the pixels on the other two opposite sides of the selected pixel are of the other intensity value, the pixels adjacent the corners of the selected pixel are examined. If more than one of the pixels adjacent the corners of the selected pixel are of the one intensity value, the selected pixel is determined to be a pixel bridge 74 such as that shown in FIG. 5a and is deemed to represent noise. In this case, the intensity value of the selected pixel is reversed. If the pixels completely surrounding three sides of the selected pixel have an intensity value that is opposite the intensity value of the selected pixel, the selected pixel is determined to be a tooth 76 such as that shown in FIG. 5b and is deemed to represent noise. In this case, the intensity value of the selected pixel is reversed. The above process is performed for each pixel in the black and white image thereby to clean the image of noise.

During locating of the candidate start and stop patterns at step 130, scans across the black and white image in both horizontal and vertical directions are performed as the orientation of the barcode symbol in the image is unknown. If a barcode symbol is oriented generally horizontally in the image, a horizontal scan will more likely traverse the entire start and/or stop patterns, allowing the barcode symbol to be located. Conversely, if a barcode symbol is oriented generally vertically in the image, a vertical scan will more likely traverse the entire start and/or stop patterns.

With the horizontal and vertical scans taken, each horizontal scan-line and each vertical scan-line in the horizontal and vertical scans is analyzed for transitions from black to white and from white to black, allowing black and white runs of pixels, or tokens, to be identified in each of the scan-lines. For each scan-line, once the black and white tokens therealong have been determined, the tokens are grouped into sets, with each set including eight (8) tokens that alternate in color. Each set of eight alternating black and white tokens is then analyzed to determine if it corresponds to that of a start or stop pattern. Specifically, the sizes of the tokens within each set are checked to see if they correspond to the widths of the bars and spaces of a start or stop pattern within a desired margin of allowable error.

The margin of error is provided for as the pixel widths of the bars and spaces in the start and stop patterns of PDF417 barcode symbol images can vary for a number of reasons. Where a handheld barcode scanner 20 is employed to scan PDF417 barcode symbols, the distance that the barcode scanner is from the barcode symbol during scanning will have an impact on the pixel widths of the bars and spaces in its start and stop patterns. Also, if the PDF417 barcode symbol in the image is skewed and takes a diagonal orientation with respect to the horizontal or vertical, the orientation of the PDF417 barcode symbol will have an impact on the pixel widths of the bars and spaces in the start and stop patterns. Notwithstanding the fact that pixel widths of the bars and spaces in the start and stop patterns of PDF417 barcode symbol images may vary, since PDF417 barcode symbols have pre-defined fixed proportions, by determining the relative proportion of each token in the set with respect to the total set size, sets of alternating black and white tokens corresponding to those of the start and stop patterns can be detected irrespective of variations in the pixel widths of the bars and spaces.

In order for a set of eight alternating black and white tokens in a scan-line to qualify as a candidate start or stop pattern, the token set must satisfy the following equation:

$$∀ i : 1 … m : \{ \frac{{S}_{a + i} - n}{{\sum }_{x = a}^{a + m} {S}_{x}} < \frac{{P}_{i}}{{\sum }_{b = 1}^{m} {P}_{b}} < \frac{{S}_{a + i} + n}{{\sum }_{x = a}^{a + m} {S}_{x}} \} \qquad ( 0.2 )$$

where:
a is the position of the token in the scan-line being checked;
Sₐ₊ᵢ is the width, in pixels, of the (a+i)^{th} token in the scan-line;
Pᵢ is the width, in modules, of the i^{th} token in the set;
m is the number of tokens in the set; and
n is the margin of allowable error in the width of a token, in pixels.

FIG. 6 shows the table stored in the non-volatile memory 16 from which the values for Pᵢ are retrieved. The table lists the relative widths of the bars and spaces, in modules, in the start and stop patterns, both in the forward and backward directions.

During analyzing of the sets of eight alternating black and white tokens, every set of eight alternating black and white tokens in each of the horizontal and vertical scan-lines is checked to detect the sets of eight alternating black and white tokens that satisfy equation (0.2) and hence, represent candidate start and stop patterns. In particular, for each set of eight alternating black and white tokens, initially the relative proportion of each token in the set with respect to the total size of the set is compared to the relative proportion of the corresponding bar or space in the start pattern with respect to the total size of the start pattern in the forward direction. If the difference between any of the compared relative proportions is not within the allowable margin of error n (i.e. if equation (0.2) is not satisfied), the set of eight alternating black and white tokens is deemed not to represent the start pattern in the forward direction. In this case, the relative proportion of each token in the set with respect to the total size of the set is compared to the relative proportion of the corresponding bar or space in the start pattern with respect to the total size of the start pattern in the backward direction. If the difference between any of the compared relative proportions is not within the allowable margin of error n, the set of eight alternating black and white tokens is deemed not to represent the start pattern in the backward direction.

If during the above process, the differences between all of the compared relative proportions in either the forward or backward direction are within the allowable margin of error, the set of eight alternating black and white tokens is deemed to be a candidate start pattern.

If the set of eight alternating black and white tokens is deemed not to represent the start pattern in either the forward or backward direction, the above steps are performed to determine if the set of eight alternating black and white tokens represents the stop pattern. Specifically, the relative proportion of each token in the set with respect to the total size of the set is compared to the relative proportion of the corresponding bar or space in the stop pattern with respect to the total size of the stop pattern in first the forward direction and then if necessary, in the backward direction. If the set of eight alternating black and white tokens is deemed not to represent the stop pattern, the set of eight alternating tokens is discarded and the next set of eight alternating black and white tokens is examined to determine if it represents a start or stop pattern.

If during the above process, the differences between all of the compared relative proportions in either the forward or backward direction are within the allowable margin of error, the set of eight alternating black and white tokens is deemed to be a candidate stop pattern.

As will be appreciated, it is necessary to check the set of eight alternating black and white tokens in both the forward and backward direction as the orientation of the PDF417 barcode symbol in the image is unknown and may be right-side up or upside down.

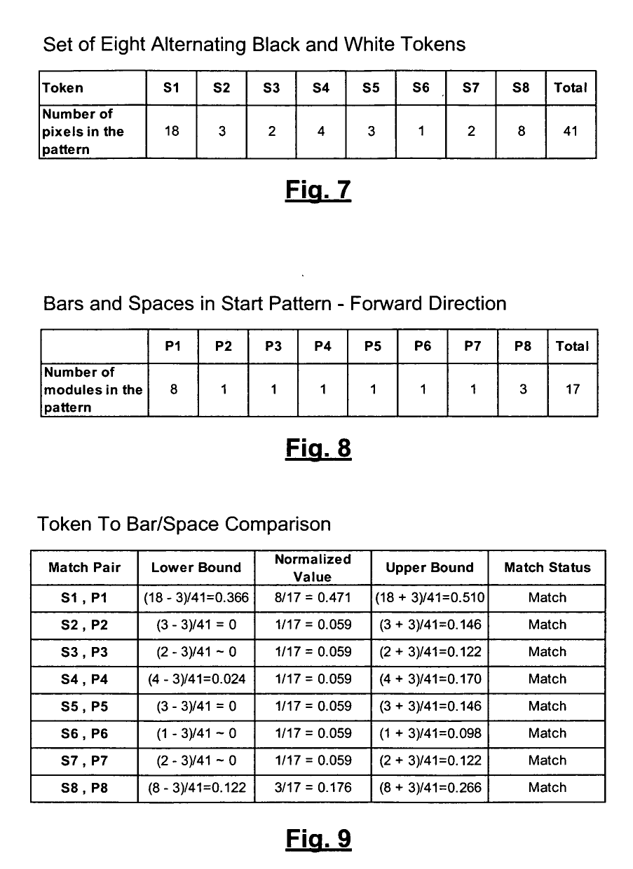

FIGS. 7, 8 and 9 illustrate the above process. As can be seen, FIG. 7 shows an exemplary set of eight alternating black and white tokens along a scan-line. In this example, the set of tokens includes a black token S1 that is 18 pixels long, a second white token S2 that is 3 pixels long, a third black token S3 that is two pixels long etc. FIG. 8 shows the number of modules for each token in an ideal start pattern to which the set of tokens of FIG. 7 is compared.

FIG. 9 shows the comparison of each token in the set of FIG. 7 with modules for each token of the ideal start pattern in the forward direction using equation (0.2). In this example, the allowable error n has been set to 3. For the first token in the set, the lower and upper bounds of equation (0.2) are determined, as is the normalized value. If the lower bound is less than zero, it is raised to zero. If the normalized value lies between the lower and upper bounds for the token, the token is deemed to be a match and the next token in the set is examined. This proceeds until all of the tokens in the set have been examined or until one token is encountered where the normalized values does not lie between the lower and upper bounds.

For each located candidate start or stop pattern, a module size is determined using the following formula:

$$\frac{{\sum }_{x = a}^{a + m} {S}_{x}}{m} \qquad ( 0.3 )$$

The module size is then recorded, along with the beginning and end pixel locations of the thick bar in the candidate start or stop pattern, the direction that the candidate start or stop pattern was located in (i.e. forwards or backward), and the pattern type (i.e. start or stop).

The above steps are performed for each set of eight alternating black and white tokens in each of the horizontal and vertical scan-lines. The end result is typically a number of candidate start and stop patterns that can be correlated. This is due to the fact that the start and stop patterns extend the full height of the PDF417 barcode symbol. The correlated candidate start and stop patterns are then grouped resulting in one or more groups of candidate start patterns and one or more groups of candidate stop patterns.

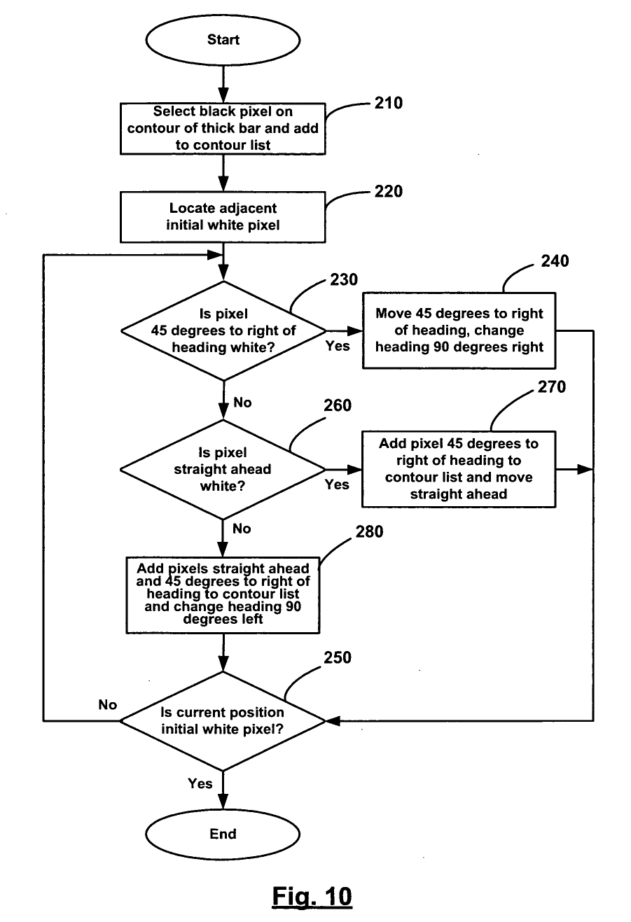

For each group, one of the candidate patterns therein is chosen and a pixel in the thick bar of the chosen candidate pattern is selected as a starting point. A contour is then traced around the thick bars in the candidate patterns pixel-by-pixel using a four-neighbor tracing approach. A heading is kept to keep track of the tracing direction so that the perimeter of only one adjacent pixel is considered. The contour-tracing algorithm traces around the contour in a clockwise direction. Each time a pixel is encountered along the contour that forms part of the same group, the confidence measure of the contour is increased and the pixel is removed from the group. This continues until all of the pixels in the candidate patterns of the group are used up. FIG. 10 shows the steps performed during contour tracing.

Initially, a black pixel on the perimeter of a thick bar in a candidate pattern is selected (step 210). The black pixel is identified by selecting the first or last black pixel in the run of black pixels that represents the thick bar of the candidate pattern. The selected black pixel is then added to a contour list. An adjacent initial white pixel is then located, starting from the nine o'clock position and proceeding clockwise (step 220). Once the initial white pixel is located, its position is registered. Also, a heading 90° to the right of the direction of the initial white pixel from the black pixel is registered as the current heading. Then, the pixel 45° to the right of the position of the initial selected black pixel and current heading is examined (step 230). If the examined pixel is white, a turn in the contour is registered. Upon registration of a turn, the current position is moved to the position of the registered initial white pixel and the heading is changed to reflect the 90° turn to the right (step 240). The current position is then examined to determine if it matches the position of the initial white pixel (step 250). If it does not, the method returns to step 230, and the same analysis is performed for the new position and heading. If the current position matches the position of the initial white pixel, the contour is deemed to have been fully traced.

At step 230, if the examined pixel 45° to the right of the current position and heading is black, the pixel directly ahead of the current position and heading is examined (step 260). If the pixel directly ahead is white, the contour is deemed not to change direction and the black pixel 45° to the right is added to the contour list. The current position is then moved one pixel directly ahead (step 270). As the heading has not changed, no heading change needs to be registered. The method then proceeds to step 250 to examine the current position to determine if it matches the position of the initial white pixel.

At step 260, if the pixel directly ahead of the current position and heading is black, the contour is deemed to turn to the left. At this stage, both pixels that are 45° to the right of the current position and heading and the pixel straight ahead of the current position and heading are added to the contour list. The heading is then shifted 90° to the left (step 280). The method then proceeds to step 250 to examine the current position to determine if it matches the position of the initial white pixel.

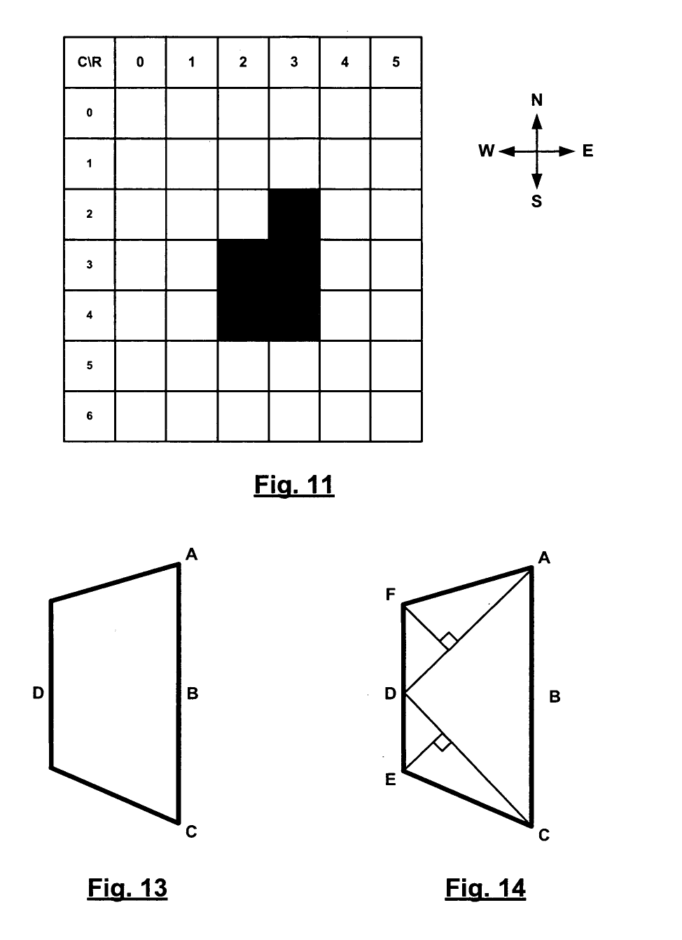

An example of counter tracing will now be described with reference to FIG. 11 assuming that the starting black pixel selected at step 210 is at coordinates (2,4), and has been registered in the contour list. Next, at step 220, an adjacent white pixel at coordinates (1,4) is found and is registered as the initial white pixel, along with a heading of north.

Next, at step 230, the pixel 45° to the right of the initial white pixel at coordinates (1,4) from the current north heading is examined i.e. the pixel at coordinates (2,3). As this pixel is black, the pixel to the north of the initial white pixel at coordinates (1,4) is examined i.e. the pixel at coordinates (1,3) (step 260). As this pixel is white, the contour is deemed not to be turning. Then, at step 280, the current position is moved to coordinates (1,3), and the pixel at coordinates (2,3) is added to the contour list. The current heading is maintained as north. At step 250, it is determined that the current position does not match the initial white pixel position, so the method reverts back to step 230.

Upon return to step 230, the pixel 45° to the right of the current position and heading is examined i.e. the pixel at coordinates (2,2). Since this pixel is white, a turn in the contour is deemed to have occurred. At step 240, the current position is moved to coordinates (2,2) and the current heading is changed to east. At 250, it is again determined that the current position does not match the initial white pixel position, so the method reverts back to step 230.

Upon return to step 230, the pixel 45° to the right of the current position and heading is examined i.e. the pixel at coordinates (3,3). As it is determined to be black, the pixel directly ahead of the current pixel is examined i.e. the pixel at coordinates (3,2) (step 250). As the pixel at coordinates (3,2) is black, the method proceeds to step 280 where the pixels at coordinates (3,3) and (3,2) are added to the contour list. The current heading is then shifted 90° to the left, or north. At step 250, it is again determined that the current position does not match the initial white pixel position, so the method reverts back to step 230.

Once again upon return to step 230, the pixel 45° to the right of the current position and current north heading is examined i.e. the pixel at coordinates (3,1). As this pixel is white, a turn in the contour is deemed to have occurred. At step 240, the current position is moved to coordinates (3,1) and the current heading is changed to east. Then, at step 250, it is determined that the current position does not match the initial white pixel position, so the method reverts back to step 230.

Once again at step 230, the pixel 45° to the right of the current position and current east heading is examined i.e. the pixel at coordinates (4,2). As this pixel is white, a turn in the contour is deemed to have occurred. The current position is moved to coordinates (4,2) and the current heading is changed to south (step 240). Then, at step 250, it is determined that the current position does not match the initial white pixel position, so the method reverts back to 230.

Again at step 230, the pixel 45° to the right of the current position and current south heading is examined i.e. the pixel at coordinates (3,3) and determined to be black. As the pixel directly ahead of the current position is determined to be white at step 260, no change in direction has been encountered. At step 270, the pixel at coordinates (3,3) is added to the contour list. The current position is then moved directly ahead to coordinates (4,3) and the current heading remains south. When the pixel at coordinates (3,3) is added to the list of contour pixels, the existence of this pixel in the contour list is noted and, thus, the pixel is not duplicated in the list. At step 250, it is determined that the current position does not match the initial white pixel position, so the method reverts back to step 230.

On the next iteration, at step 260, the contour is deemed not to turn and thus, the pixel at coordinates (3,4) is added to the contour list. The current position is then moved ahead to coordinates (4,4) and the current heading remains south. At step 250, it is determined that the current position still does not match the initial white pixel position, so the method reverts back to step 230.

During the next iteration at step 230, the pixel 45° to the right of the current position and current south heading is examined i.e. the pixel at coordinates (3,5). As this pixel is white, a turn in the contour is deemed to have occurred. At step 250, the current position is moved to coordinates (3,5) and the current heading is changed to west. At step 250, it is once again determined that the current position does not match the initial white pixel position, so the method reverts back to step 230.

At step 230, the pixel 45° to the right of the current position and current west heading is examined i.e. the pixel at coordinates (2,4) and is determined to be black. As the pixel directly ahead of the current position is determined to be white at step 250, no change in direction has been encountered. At step 270, the current position is moved forward to coordinates (2,5) and the current heading remains unchanged at west. As the pixel at coordinates (2,4) has been previously added to the contour list, it is not re-added. Then, at step 250, it is again determined that the current position does not match the initial white pixel position, so the method reverts back to step 230.

On the last iteration of step 230, the pixel 45° to the right of the current position and current west heading is examined i.e. the pixel at coordinates (1,4), which is the initial starting pixel. As this pixel is white, a turn in the contour to the right is deemed to have occurred. At step 240, the current position is moved to coordinates (1,4) and the heading is changed to north. Then, at 250, the current position is determined to be that of the initial white pixel thereby to complete contour tracing.

After the contour has been traced around the thick bars in the candidate patterns of each group, the center of gravity and average module size for each traced contour are determined and registered. Generally, two traced contours representing the thick bars of the start and stop patterns will be validated.

To validate a traced contour, a confidence score system is established to determine the likelihood that a contour traces the thick bar of a start or stop pattern. The validity of the contour is determined by three conditions. In particular, the distance of the traced contour must not exceed 1.5 times the width of the image. The center of gravity of the traced contour must be a black pixel. The two diagonals of the traced contour must have at least 80% black pixels, or run through at least thirty (30) consecutive black pixels. The traced contour is validated only if all three conditions are satisfied. If any of the three conditions are not satisfied, the traced contour is deemed not to be one that traces the thick bar of a start or stop pattern.

Once the traced contours have been validated, the traced contours are used to determine the vertices of the thick bars of the start and stop patterns. FIG. 12 better illustrates the manner by which the vertices are determined at step 150. For each traced contour, initially the two most separated pixels along the contour are determined. This is achieved by comparing the straight-line distance between each pair of pixels along the contour and finding the pair of pixels having the greatest distance between them (step 300). The pair of pixels A and C having the greatest distance between them are assumed to be at opposite vertices defining a diagonal of the thick bar, line AC. Next, the remaining vertices B and D of the thick bar are estimated (step 310).

During step 310, the pixels along the contour between pixels A and C are analyzed firstly in a clockwise direction to find the pixel B along the contour having the greatest perpendicular distance from line AC. The pixels along the contour between pixels A and C are then analyzed in a counterclockwise direction to find the pixel D having the largest perpendicular distance from line AC.

The perpendicular distance between pixel B and line AC is then compared with the perpendicular distance between pixel D and line AC to determine if they are similar or vary significantly (step 320). In the present implementation, the perpendicular distances are deemed to vary significantly if they differ by a factor of two or more. In cases where the thick bar is not very rectangular, the perpendicular distances can vary significantly.

If the perpendicular distances vary significantly the estimated vertices are considered inaccurate and are corrected. During vertex correction, the candidate vertex B is deemed to be incorrect and is assigned point C (step 330). The vertex originally at point C is therefore also deemed to be incorrect and is redetermined by setting it to the point on the contour between the vertices C and D that has the greatest perpendicular distance from the line CD, thereafter referred to as point E (step 340). The vertex D is also deemed to be incorrectly located and is set to the point on the contour between vertices D and A that has the greatest perpendicular distance from line DA, referred to as point F (step 350). At this stage the vertices of the thick bar are corrected completing the vertex determination process.

If at step 320, the perpendicular distances do not vary significantly, the estimated vertices B and D are considered to be accurate and thus, their positions are simply fine-tuned. During fine-tuning, the pixel G is located clockwise along the contour between vertices A and C that has the greatest total of the distance from vertex D and the perpendicular distance from line AC (step 360). This allows the location of the vertex B to be fine-tuned. Then, in order to fine-tune the location of the vertex D, the pixel H is located clockwise along the contour between the vertices C and A that has the greatest total of the distance from the vertex B and the perpendicular distance from line AC (step 370). Vertex B is then set to the position of point G and vertex D is set to the position of point H (step 380) thereby completing the vertex determination process.

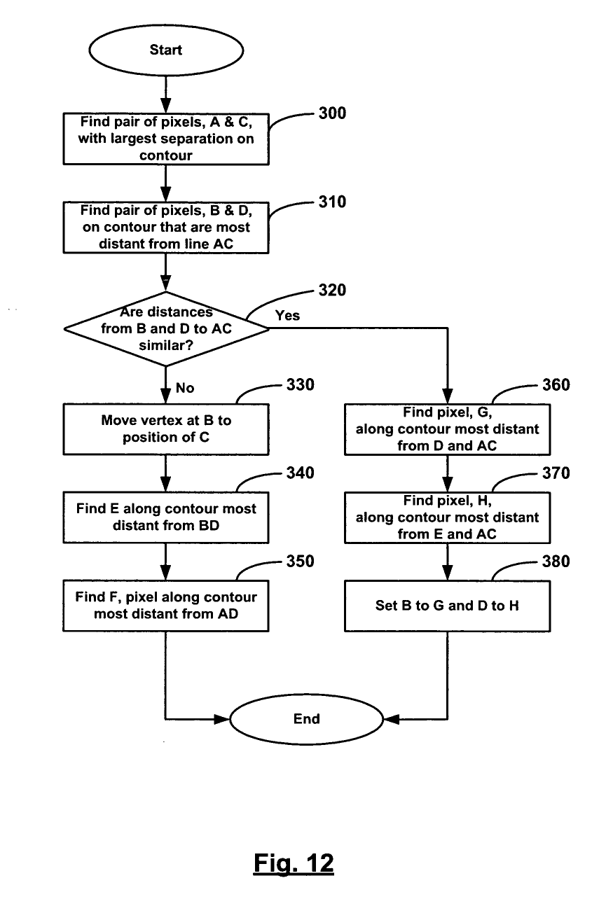

FIG. 13 shows the contour of a distorted thick bar for which vertex B is determined to be effectively along the line AC at step 320. As a result, the perpendicular distance between vertex B and line AC is effectively zero. Thus, a comparison of the perpendicular distance between vertex B and line AC with the perpendicular distance between vertex D and line AC indicates that they vary significantly. FIG. 14 shows the contour of the distorted thick bar after adjustment of the vertices in accordance with steps 330 to 350.

In contrast, FIG. 15 shows the center of a distorted thick bar wherein the perpendicular distances between vertices B and D and line AC are determined at step 320 to be relatively similar. In this case, the vertices B and D are simply trued at steps 360 to 380. This is done to compensate for bumps and blips in the traced contour that may be created as a result of image sharpening and thresholding.

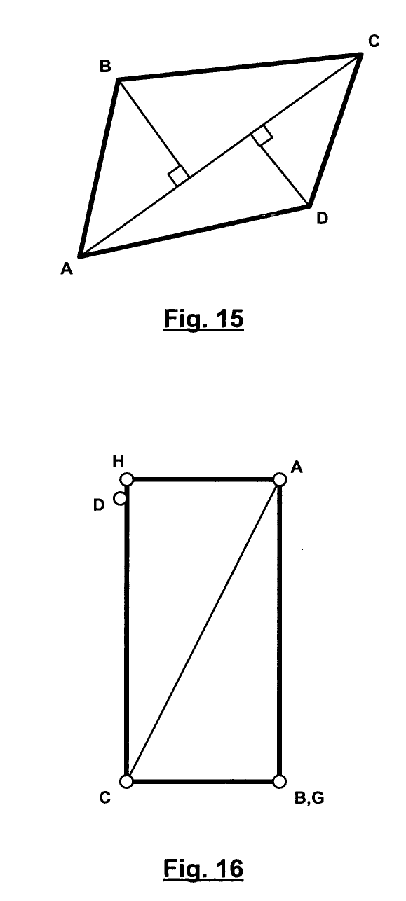

FIG. 16 shows a generally rectangular thick bar having vertices A, B, C and D determined at steps 300 and 310. In this case, vertices A, B and C are true vertices but vertex D is not a true vertex. During steps 360 and 380, the position of vertex D is shifted to point H.

As it is memory-intensive to keep track of each pixel along the contours, and as much of this information is not required for other purposes, it is desired to discard as much of this information as possible. In fact, only the four corner vertices of the thick bars of the start and stop patterns, and the centers of gravity of the thick bars, are required to decode the encoded data. Thus, once the four vertices and centre of gravity have been determined for each thick bar, the remaining pixel data relating to the contours are discarded.

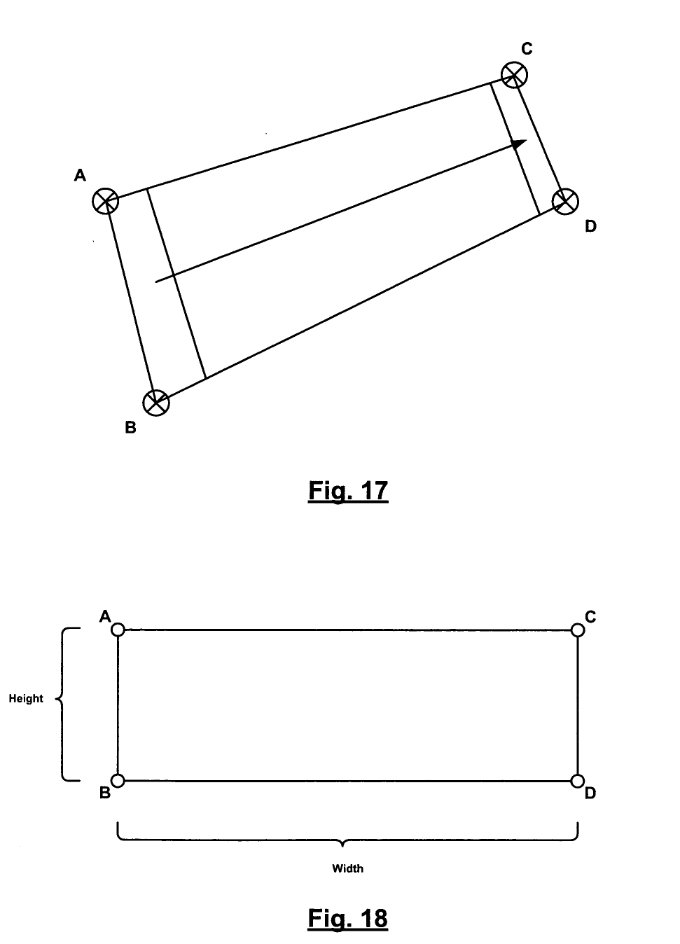

During matching of the start and stop patterns at step 160, a scan-line from the center of gravity of the thick bar in the start pattern to the center of gravity of the thick bar in the stop pattern is analyzed to confirm that no bar or space width is wider than six times the average module width of the start and stop patterns. Then, the direction of the start and stop patterns is compared along the scan-line to ensure they form part of the same barcode or read line; that is, that they have the same orientation. Next, the two vertices of the thick bar in the start pattern and the two vertices of the thick bar in the stop pattern that are at opposite ends of the scan-line are determined and are deemed to be the outer vertices of the barcode symbol. FIG. 17 shows an exemplary barcode symbol outline showing the four outer vertices of the barcode symbol.

The transformation of the barcode symbol at step 170 results in a rectangular transformed barcode symbol with zero degrees of rotation and no distortion, as is shown in FIG. 18. Using the four outer vertices of the barcode symbol determined during step 160, a rectangle is calculated with the following dimensions:

Height=Max((distance from A to B), (distance from C to D))

Width=Max((distance from A to C), (distance from B to D))

A projective transform matrix is calculated which maps all of the outer vertices of the barcode symbol to the calculated rectangle. The transform is carried out only on the section of the image containing the barcode symbol. Each dimension in the calculated rectangle is twice as large as the original barcode region. Thus, the barcode region is enlarged by a factor of four.

During extraction of data from the scan-lines through the transformed barcode symbol at step 180, the start and stop patterns are removed from each read line. The following information from the PDF417 Specification concerning the format of PDF417 barcode symbols is required to understand the analysis.
Every codeword begins with a bar and ends with a space and is only eight transitions long;
Every row of codewords belongs to one of cluster 0, cluster 3 or cluster 6;
The same cluster usage repeats every three rows, in a sequence. Row 1 uses cluster 0, row 2 uses cluster 3, row 3 uses cluster 6, row 4 uses cluster 0, etc;
The right row indicator of the first row holds the number of columns in the data matrix of the barcode symbol; and
The left row indicator of the first row holds the number of rows in the data matrix of the barcode symbol.

In order to extract data from the scan-lines, sets of eight alternating black and white tokens distinguished by transitions and that begin with a bar and end with a space in a given scan-line are identified and analyzed. If a given set of eight tokens represents a valid cluster (0, 3 or 6) and the valid cluster is the current cluster being examined, a column number and a row number are identified for the codeword and the codeword is added to a list. The next eight transitions from the end of the current eight transitions are then checked.

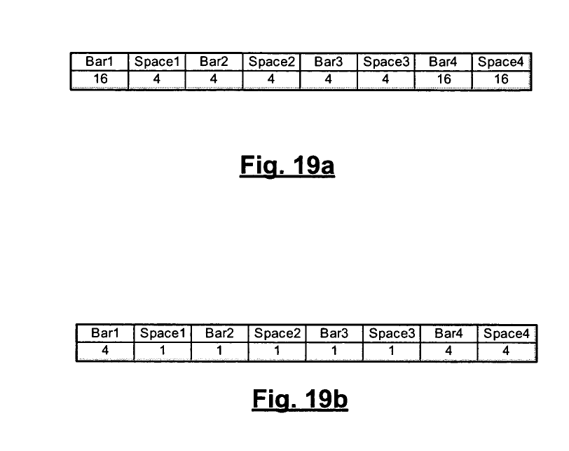

FIG. 19a shows a pixel count corresponding to a set of eight alternating black and white tokens along a scan-line. The values are normalized by determining the size of one module to be equal to the total number of pixels, 68, divided by the number of modules in a codeword, 17, to yield a module size of four. The normalized values for the tokens and spaces are shown in FIG. 19b. These normalized values are then used to determine the cluster, according to the following formula:
cluster=(Bar1−Bar2+Bar3−Bar4+9)mod 9 (0.4)
Thus, the codeword represented by the values shown in FIGS. 19a and 19b represents cluster 0(=(0+9)mod 9).

The current column number of the codeword is located by taking the space between the end of the last found codeword and the end of the current codeword, dividing it by the average size of both codewords, and adding the result to the last found column number. If a codeword represents a cluster that is not the current cluster, this information is recorded in a cluster count array. A cluster change can only occur if the cluster count array shows counts for the next cluster as the highest counts. For example, if the current cluster is cluster 0, and the cluster count array shows counts for cluster 3 as the highest, then a cluster change has occurred and thus a row change has also occurred. The row counter is incremented in response. If the current cluster is 0 and the cluster count array shows counts for cluster 6 as the highest, the current cluster is deemed not to have changed.

After all of the scan-lines have been analyzed, a codeword array is built from the linked codewords. Any duplicate codewords that belong to the same row and column add to the confidence of the codeword. If two different codewords represent the same row and column, the codeword with the highest confidence is selected.

Once the codeword array is built, the column length of the codeword array is verified using the right row indicator of the first row. If the number of columns does not match the right row indicator, the number of columns is decremented and the right row indicator is checked again to see if it matches the number of columns. This is repeated until the number of columns matches the right row indicator.

During the processing of the codeword array to decode the data at step 190, the left and right row indicators are discarded as they do not constitute actual data. The number of rows of data contained in the codeword array is then verified by ensuring the codeword array contains between 3 and 90 rows of data. At least one column of codewords must be present, otherwise the codeword array is invalid. Also, the number of error correction codewords is identified. This is determined by subtracting the number of data codewords from the total number of codewords.

Error correction in the codeword array is performed by subjecting the bitstream to Reed-Solomon error correction. If there are too many errors and Reed-Solomon error correction is unable to correct all of the errors, the codeword array is not decoded and the PDF417 barcode symbol is deemed to be unreadable. After successful error correction, the data codewords in the array are decoded according to the PDF417 Specification.

While the present invention has been described with specificity to PDF417 barcode symbols, those of skill in the art will appreciate that the present invention may be used during processing of other types of barcode symbols. For example, the method can be applied to QR Code Data, Data Matrix and other barcode symbols having characters that can be delineated.

The barcode symbol decoding software may include modules to handle the various steps performed during the barcode symbol decoding process. Although the barcode symbol decoding software is described as being stored in non-volatile memory, the barcode decoder software may be stored on virtually any computer readable medium that can store data, which can thereafter be read by a computer system or other processing device. Examples of such computer readable medium include read-only memory, random-access memory, CD-ROMs, magnetic tape and optical data storage devices. The computer readable program code can also be distributed over a network including coupled computer systems so that the computer readable program code is stored and executed in a distributed fashion.

Although embodiments of the present invention have been described, those of skill in the art will appreciate that variations and modifications may be made without departing from the spirit and scope thereof as defined by the appended claims.

What is claimed is:

1. A method of determining the vertices of a character in a two-dimensional barcode symbol image comprising:
tracing a contour around said character;
examining the contour and determining pixels therealong believed to be vertices of said character;
comparing the relative positions of the determined pixels to determine if they satisfy a threshold;
if the relative positions of the determined pixels satisfy the threshold, designating the determined pixels as the vertices of said character; and
if the relative positions of the determined pixels do not satisfy the threshold, selecting new pixels along said contour using geometric relationships between the determined pixels to replace determined pixels that are not vertices of said character.

2. The method of claim 1 wherein during said examining, pixels believed to be vertices of said character are determined in pairs.

3. The method of claim 2 wherein during said examining, a first pair of determined pixels representing one set of vertices of said character is initially determined and thereafter, a second pair of determined pixels believed to represent another set of vertices of said character is estimated.

4. The method of claim 3 wherein during selecting, the determined pixels of said second pair are replaced.

5. The method of claim 4 further comprising, after said comparing has determined that the relative positions of the determined pixels satisfy the threshold, performing fine-tuning to select new pixels along said contour to replace determined pixels of the second pair that are near to but are not vertices of the character.

6. The method of claim 4 wherein said examining comprises:
comparing the distance between each pair of pixels along the contour to locate the pair of pixels having the greatest distance therebetween thereby to locate said first pair of determined pixels; and
determining the two pixels along said contour on opposite sides of a line joining the determined pixels of said first pair that are furthest from said line thereby to locate said second pair of determined pixels.

7. The method of claim 6 wherein comparing the relative positions of determined pixels comprises:
determining the perpendicular distance between each determined pixel of said second pair to said line; and
comparing the determined distances to determine if they vary beyond said threshold.

8. The method of claim 7 wherein the determined distances are determined to vary beyond said threshold if the determined distances vary by a factor of two or more.

9. The method of claim 8 wherein when the determined distances vary beyond said threshold, said selecting comprises:
determining the pixel along the contour that is furthest from a line joining one of the determined pixels of said first pair and the determined pixel of said second pair that is furthest from the line joining the determined pixels of said first pair; and
determining the pixel along the contour that is furthest from a line joining the other of the determined pixels of said first pair and the determined pixel of said second pair that is furthest from the line joining the determined pixels of said first pair.

10. The method of claim 9 wherein said fine-tuning comprises:
for each pixel along the contour joining the determined pixels of the first pair in a first direction:
calculating the distance between the pixel and the line joining the determined pixels of the first pair;
calculating the distance between the pixel and the furthest determined pixel of the second pair; and
summing calculated distances to yield a first resultant sum;
determining the pixel yielding the greatest first resultant sum thereby to select a new vertex of said character;
for each pixel along the contour joining the determined pixels of the first pair in a second opposite direction:
calculating the distance between the pixel and the line joining the determined pixels of the first pair;
calculating the distance between the pixel and the furthest determined pixel of the second pair; and
summing calculated distances to yield a second resultant sum;
determining the pixel yielding the greatest second resultant sum thereby to select a new vertex of said character.

11. The method of claim 5 wherein said fine-tuning comprises:
for each pixel along the contour joining the determined pixels of the first pair in a first direction:
calculating the distance between the pixel and the line joining the determined pixels of the first pair;
calculating the distance between the pixel and the furthest determined pixel of the second pair; and
summing calculated distances to yield a first resultant sum;
determining the pixel yielding the greatest first resultant sum thereby to select a new vertex of said character;
for each pixel along the contour joining the determined pixels of the first pair in a second opposite direction:
calculating the distance between the pixel and the line joining the determined pixels of the first pair;
calculating the distance between the pixel and the furthest determined pixel of the second pair; and
summing calculated distances to yield a second resultant sum;
determining the pixel yielding the greatest second resultant sum thereby to select a new vertex of said character.

12. The method of claim 1 wherein said character is generally rectangular in shape.

13. The method of claim 12 wherein said character forms part of a designated pattern in said two-dimensional barcode symbol.

14. The method of claim 13 wherein said designated pattern is one of a start and stop pattern forming part of a PDF417 barcode symbol.

15. The method of claim 14 wherein said character is a thick bar in said pattern.

16. The method of claim 15 wherein during said examining, pixels believed to be vertices of said character are determined in pairs.

17. The method of claim 16 wherein during said examining, a first pair of determined pixels representing one set of vertices of said character is initially determined and thereafter, a second pair of determined pixels believed to represent another set of vertices of said character is estimated.

18. The method of claim 17 wherein during selecting, the determined pixels of said second pair are replaced.

19. The method of claim 18 further comprising, after said comparing has determined that the relative positions of the determined pixels satisfy the threshold, performing fine-tuning to select new pixels along said contour to replace determined pixels of the second pair that are near to but are not vertices of the character.

20. The method of claim 19 wherein said examining comprises:
comparing the distance between each pair of pixels along the contour to locate the pair of pixels having the greatest distance therebetween thereby to locate said first pair of determined pixels; and
determining the two pixels along said contour on opoposite sides of the line joining the determined pixels of said first pair that are furthest from said line thereby to locate said second pair of determined pixels.

21. The method of claim 20 wherein comparing the relative positions of determined pixels comprises:
determining the perpendicular distance between each determined pixel of said second pair to said line; and
comparing the determined distances to determine if they vary beyond said threshold.

22. The method of claim 21 wherein the determined distances are determined to vary beyond said threshold if the determined distances vary by a factor of two or more.

23. The method of claim 22 wherein when the determined distances vary beyond said threshold, said selecting comprises:
determining the pixel along the contour that is furthest from a line joining one of the determined pixels of said first pair and the determined pixel of said second pair that is furthest from the line joining the determined pixels of said first pair; and
determining the pixel along the contour that is furthest from a line joining the other of the determined pixels of said first pair and the determined pixel of said second pair that is furthest from the line joining the determined pixels of said first pair.

24. The method of claim 23 wherein said fine-tuning comprises:
for each pixel along the contour joining the determined pixels of the first pair in a first direction:
calculating the distance between the pixel and the line joining the determined pixels of the first pair;
calculating the distance between the pixel and the furthest determined pixel of the second pair; and
summing calculated distances to yield a first resultant sum;
determining the pixel yielding the greatest first resultant sum thereby to select a new vertex of said character;
for each pixel along the contour joining the determined pixels of the first pair in a second opposite direction:
calculating the distance between the pixel and the line joining the determined pixels of the first pair;
calculating the distance between the pixel and the furthest determined pixel of the second pair; and
summing calculated distances to yield a second resultant sum;
determining the pixel yielding the greatest second resultant sum thereby to select a new vertex of said character.

25. The method of claim 19 wherein said fine-tuning comprises:
for each pixel along the contour joining the determined pixels of the first pair in a first direction:
calculating the distance between the pixel and the line joining the determined pixels of the first pair;
calculating the distance between the pixel and the furthest determined pixel of the second pair; and
summing calculated distances to yield a first resultant sum;
determining the pixel yielding the greatest first resultant sum thereby to select a new vertex of said character;
for each pixel along the contour joining the determined pixels of the first pair in a second opposite direction:
calculating the distance between the pixel and the line joining the determined pixels of the first pair;
calculating the distance between the pixel and the furthest determined pixel of the second pair; and
summing calculated distances to yield a second resultant sum;
determining the pixel yielding the greatest second resultant sum thereby to select a new vertex of said character.

26. An apparatus for determining the vertices of a character in a two-dimensional barcode symbol image comprising:
a contour tracer for tracing a contour around the character;
a vertices determiner examining the contour and determining pixels along the contour believed to be vertices of the character; and
a vertices corrector comparing the relative positions of the determined pixels to determine if they satisfy a threshold, if the relative positions of the determined pixels satisfy the threshold, said vertices corrector designating the determined pixels as the vertices of the character and if the relative positions of the determined pixels do not satisfy the threshold, the vertices corrector selecting new pixels along the contour using geometric relationships between the determined pixels to replace determined pixels that are not vertices of the character thereby to correct the vertices.

27. An apparatus according to claim 26 wherein if the relative positions of the determined pixels satisfy the threshold, the vertices corrector performs fine-tuning to select new pixels along the contour to replace determined pixels that are near to but are not vertices of the character.

28. An apparatus according to claim 27 wherein said character is generally rectangular and forms part of a PDF417 barcode symbol image.

29. An apparatus according to claim 28 wherein said character is the thick bar in a start or stop pattern.

30. A method of determining the vertices of a generally rectangular character in a two-dimensional barcode symbol comprising:
examining said character to determine a first pair of vertices of said character;
using the determined pair of vertices to estimate a second pair of vertices of said character;
comparing the relative positions of the determined and estimated vertices to determine if the estimated vertices are accurate; and
if the estimated vertices are inaccurate, re-estimating the second pair of vertices using geometric relationships between the determined and estimated vertices.

31. The method of claim 30 wherein the first pair of vertices are determined by detecting the two points along the perimeter of the character that have the greatest distance therebetween.

32. The method of claim 31 wherein the second pair of vertices are estimated by detecting the two points that are on opposite sides of and furthest from a line joining the vertices of said first pair.

33. The method of claim 32 wherein if the estimated vertices are accurate, the positions of the estimated vertices are verified and re-adjusted, if necessary.

34. The method of claim 33 wherein the estimated vertices are deemed to be accurate if the distances between the two points and the line are within a threshold.

35. A method of decoding a two-dimensional barcode symbol in a captured image comprising:
locating start and stop patterns forming part of the barcode symbol;
tracing a contour around at least a portion of each of the located start and stop patterns;
determining the vertices of the traced contours, said determining comprising:
examining each traced contour to determine a first pair of vertices;
using the determined pair of vertices to estimate a second pair of vertices;
comparing the relative positions of the determined and estimated vertices to determine if the estimated vertices are accurate; and
if the estimated vertices are inaccurate, re-estimating the second pair of vertices using geometric relationships between the determined and estimated vertices;
using the determined vertices to re-orient the barcode symbol; and
reading the re-oriented barcode symbol to extract the data therein.

36. The method of claim 35 wherein the contours are traced around a designated character of the located start and stop patterns.

37. The method of claim 36 wherein the determined vertices that positioned at the ends of the barcode symbol are used to re-orient the barcode symbol.

38. The method of claim 37 further comprising conditioning the image prior to locating the start and stop patterns.

39. The method of claim 38 wherein said conditioning includes at least one of image sharpening, image thresholding and noise removing.

40. The method of claim 39 wherein said conditioning includes each of image sharpening, image thresholding and noise removing.
